(19) United States
(12) Patent Application Publication
(10) Pub. No.: US 2012/0151998 A1
(43) Pub. Date: Jun. 21, 2012

(54) WETTABILITY AND MATRIX IMBIBITION ANALYSIS

(75) Inventors: Dean Willberg, Tucson, AZ (US); Markus Pagels, West Jordan, UT (US); Jerald J. Hinkel, Houston, TX (US)

(73) Assignee: Schlumberger Technology Corporation, Cambridge, MA (US)

(21) Appl. No.: 12/974,276

(22) Filed: Dec. 21, 2010

(51) Int. Cl. G01N 15/08

(52) U.S. Cl. 73/38

(57) ABSTRACT

A method of determining wettability of a rock sample, such as from a core sample is described. The sample is preferably crushed or comminuted to a particulate size where micro fractures have been eliminated, but where the particles are still large enough to represent the native rock matrix and texture. The comminuted core sample is exposed to a test fluid for a given period of time. The rock sample can be split into many separate aliquots, and a series of tests is performed using a series of different fluids and/or the same fluid for different exposure times. The excess test fluid residing on the surfaces of sample particles is removed. The test fluid imbibed into the interior of the particulate sample is then measured. The test fluid can be, for example, water, a non-aqueous fluid, and/or a solution of miscible solvents. The technique used to measure the imbibed fluid depends on the solvent (imbibing fluid) being studied. In one example, this technique includes both gravimetric determination and quantitative chemical analysis. The detection of water can be via Karl Fischer titration.

### FIELD

The patent specification is generally related to hydrocarbon recovery from low permeability sources. More particularly, this patent specification relates to deducing wettability from imbibition analysis of rock samples from low permeability sources.

### BACKGROUND

Recovering hydrocarbons such as oil and gas from high permeability reservoirs is well understood. However, recovery of hydrocarbon resources from low-permeability reservoirs is difficult and less well understood. Consequently, operators have until recently tended to bypass low permeability reservoirs such as shales in favor of more conventional reservoirs such as sandstones and carbonates. A shale reservoir typically includes a matrix of small pores and may also contain naturally occurring fractures/fissures (natural fractures). These natural fractures are most usually randomly occurring on the overall reservoir scale. The natural fractures can be open (have pore volume) under in-situ reservoir conditions or open but filled in with material (have very little or no pore volume) later in geologic time; for example, calcite (CaCO₃). These fractures can also be in a closed-state (no pore volume) due to in-situ stress changes over time. Natural fractures in any or all of these states may exist in the same reservoir. For more complete understanding of the occurrence, properties, behavior, etc. of naturally fractured reservoirs in general, one may review the following references: Nelson, Ronald A., Geologic Analysis of Naturally Fractured Reservoirs (2nd Edition), Elsevier, and Aguilera, Roberto, Naturally Fractured Reservoirs, PennWell Publishing. The permeability of the shale matrix is typically quite low, e.g., in the less than one millidarcy range. In a shale gas reservoir, this presents a problem because the matrix contains most of the hydrocarbons. Since the wettability of the low permeability matrix affects fluid movement, it would be useful to understand mass transfer of hydrocarbons from the matrix

Research related to low permeability formations includes Katsube, T. J., “Shale permeability and pore-structure evolution characteristics”, Geological Survey of Canada, Current Research 2000-E15 (2000), which describes several pore structure models, and mercury intrusion and extrusion data. So-called “storage pores” that are dead-ended, but contain fluids, are identified from extrusion data. However, according to Katsube the storage pores do not contribute to the migration of fluids through the rock formation. Imbibition, a process where a wetting fluid spontaneously displaces a non-wetting fluid from a porous medium has long been recognized as an effective means to enhance recovery of oil from low permeability, naturally fractured reservoirs. For example, Hirasaki, G. and Zhang, D., “Surface Chemistry of Oil Recovery From Fractured, Oil-Wet Carbonate Formation”, SPE 80988 (2003) describe capillary pressure and the effects of surface chemistry on imbibition for oil recovery. Penny, G. S., Pursley, J. T., and Clawson, T. D., “Field Study of Completion Fluids to Enhance Gas Production in the Barnett Shale”, SPE 100434 (2006) and Paktinat, J., Pinkhouse, J. A., Williams, C., Clark, G. A., and Penny, G. S., “Field Case Studies: Damage Preventions Through Leakoff Control of Fracturing Fluids in Marginal/Low-Pressure Gas Reservoirs”, SPE 100417 (2006), which are related to stimulation treatments of shale, emphasize water sensitivity and the need to remove water from the well soon after treatments using aqueous fluids. Li, K. and Home, R. N., “Characterization of Spontaneous Water Imbibition into Gas-Saturated Rocks”, SPE 62552 (2000), provided an early analysis of the process where water is spontaneously imbibed into gas-saturated rocks. The authors note that this process is important to water coning in cases where naturally fractured gas reservoirs are positioned over active aquifers, but no mention is made of enhanced recovery. Experimental results using packs of glass beads and Berea cores showed water imbibition to be a piston-like displacement process. Based upon this observation, the authors formulated a theoretical model that accounts for both effective water permeability and capillary pressure. Generally, the permeability of the media was greater than 500 millidarcy (mD). Babadagli, T., Hatiboglu, C. U., “Analysis of counter-current gas-water capillary imbibition transfer at different temperatures”, Journal of Petroleum Science and Engineering 55 (2007) 277-93 describes the counter-current flow phenomenon. The authors speculate that imbibition in gas-liquid systems is different from the case of liquid-liquid systems as might be encountered in oil recovery. Despite a favorable mobility ratio, the authors point out that entrapment of the non-wetting gas phase is likely due to high surface tension. The authors also point out that an efficient matrix-fracture interaction based on the matrix characteristics could be achieved via controllable parameters such as the viscosity and surface tension of the injected fluid. Experiments using Berea cores indicate that less gas trapping occurs when the viscosity and interfacial tension of the imbibing fluid are lowered. The authors note lower surface tension at higher test temperature, e.g., 72.9 dynes/cm at 20° C. vs. 60.8 dynes/cm at 90° C., and they discuss the effect of lower surface tension. The permeability of the porous media tested by Babadagli et al., a sandstone and a limestone, are 500 and 15 mD respectively, which are 5-6 orders of magnitude greater than the matrix permeability of typical gas shale reservoirs being developed today.

It is widely believed that water imbibition into a reservoir from a well that will be used for production is deleterious in several ways. See, for example, Bennion, D. B., et al., “Low Permeability Gas Reservoirs: Problems, Opportunities and Solutions for Drilling, Completion, Stimulation and Production,” SPE 35577, Gas Technology Conference, Calgary, Alberta, Canada, Apr. 28-May 1, 1996, and Bennion, D. B., et al., “Formation Damage Processes Reducing Productivity of Low Permeability Gas Reservoirs,” SPE 60325, 2000 SPE Rocky Mountain Regional/Low Permeability Reservoirs Symposium and Exhibition, Denver, Colo., Mar. 12-15, 2000. Imbibed water increases the water saturation and is thought to become trapped and to block hydrocarbon flow. If imbibed water is fresher (less salinity) than formation water, it may affect fresh water sensitive expanding clays. Furthermore, imbibition of water into formations such as shale during drilling may be responsible for spalling and wall collapse. For these reasons, operators often try to complete wells with non-aqueous fluids. Water invasion of reservoirs, except in water-flooding with distinct injectors and producers, is considered a damage mechanism and is to be avoided.

Therefore, there is a history of laboratory experimental methods being developed for studying water imbibition into conventional cores (see Earl Amott, Observations Relating to the Wettability of Porous Rock, SPE 1167-G 1959 and Yongfu Wu, Patrick J. Shuler, Mario Blanco, Yongchun Tang, and William A. Goddard III, An Experimental Study of Wetting Behavior and Surfactant EOR in Carbonates With Model Compounds, SPE 99612-PA 2008). However, there has been little success in applying these methods to nano-to-micro Darcy mudstone, siltstone and shale formations. We will refer to these unconventional formations as gas shales, but they often produce liquid hydrocarbons in significant quantities as well.

There are at least three major problems when conventional methods of measuring imbibition are applied to nanoDarcy formations:
1. The length of time of a conventional Amott test on an unconventional core can be excessive due to the ultralow permeabilities of these nanoDarcy formations. Furthermore, the volume of fluid imbibed can be very small due to the low porosity (typically less than 8%) of these samples.
2. The coring process, and “de-stressing” of the core during extraction cause extensive micro fracturing of nanoDarcy core samples. FIG. 1 illustrates a plug 110 having exterior micro fractures, such as micro fracture 112, that have been contaminated by coring fluid. These “artificial” high-permeability micro fractures 112 overwhelm the laboratory measurement of any transport property for unconventional rocks. The application of a suitable confinement stress on a core plug can—but not necessarily will—close some of these micro fractures. Thus, a method to eliminate the impact of these micro fractures on the measured physical properties of the rock is desirable.
3. There can be significant sample-to-sample variation in the amount of fluid imbibed due to phase trapping in the relatively large cores. Initial laboratory testing has shown that phase trapping varies significantly from one core to the next (in the same rock) due to subtle differences in rock texture, differences in artificial micro fractures and likely due to scaling effects determined by the size of the core. In fact phase-trapping could prevent the sample from reaching full saturation—even for extremely long duration tests. FIG. 2 illustrates an example of trapped pockets of gas in a micro fractured water wet rock. The region 216 of rock 210 have imbibed fluids. The medium, although quite water wet and prone to imbibition of water, exhibits pockets of gas, such as pocket 212, trapped in the tight matrix. The extent to which phase trapping occurs is dictated by the rock texture and micro fractures, such as micro fracture 214, in the rock 210 Therefore, if one wanted to get a reasonably accurate measurement of the fluid imbibition in the subterranean environment, many repeat experiments on the same region of cored rock would need to be performed. In most cases we do not have the luxury of having that much core.

Further, core is costly, it is therefore desirable to allow for full characterization of a cored rock with very little material. One embodiment of the method of the invention allows us to test the impact of many additives and fluids on a relatively small quantity of core.

Fluid imbibition is the direct result of capillary pressure and therefore of the wetting characteristics of the surface of the pores in the rock. The literature contains a number of references that focus on measuring the wetting behavior of formation rock using various types of contact angle measurement devices. In particular the goniometer method has been employed. This method suffers from two major downfalls. First, the surface needs significant alteration—cutting and polishing—before any measurement can be made. Second, even after polishing, the surface is rough and chemically variable on all dimensional scales—the pore scale in particular. Those familiar with the art realize that the value of goniometric measurements for studying the wetting condition of rough porous samples is extremely limited has no theoretical basis and in most cases the results are irrelevant from a quantitative perspective. Other known methods include: the API Recommended Practice 40 that describes KF titration as a means to determine water in core (see API 40 “Recommended Practices for Core Analysis, 1998); the Karl Fischer Titration for soils minerals and building materials (see M. K. Zellis, J. S. Bell and Lyle Prunty, Soil Water Content Determination by Karl Fischer Titration Soil Science Society of America Journal 1998 62: 1: 257-262) and the GRI method for determining permeability (see D. L. Luffel; C. W. Hopkins; and P. D. Schettler Jr., Matrix Permeability Measurement of Gas Productive Shales. SPE 26633, 1993). The measurement of the water saturation alone does not determine the wettability of the porous medium.

### SUMMARY

Embodiments of the method of the invention enable quantitative measurement and rate of fluid imbibition into the un-adulterated pore structure of low or ultra-low permeability rocks. Furthermore this method is designed to generate results that closely match that of the formation rock matrix in its native state without coring-induced artificial micro fractures. Embodiments of this invention provide an improved means of precisely measuring the rate and extent of both the water saturation, and the change of water saturations in low-permeability rock.

According to some embodiments, a method to measure the water or solvent content of a rock core is provided. A core sample is preferably crushed or comminuted to a particulate size where micro fractures have been eliminated, but where the particles are still large enough to represent the native rock matrix and texture (that is the pore structure in the particles is identical to the pore structure in the native rock). For example, the disaggregated material can be prepared (e.g. using grinding) from a core sample or could be obtained from mines (such as for coalbed methane). The comminuted core sample is exposed to a test fluid for a given period of time. In an embodiment of the method, the rock sample is split into many separate aliquots, and a series of tests is performed using a series of different fluids or a series of measurements taken at different times.

The excess test fluid residing on the surfaces of sample particles (surface film) is removed prior to the water (or solvent) determination step. The fluid imbibed into the interior of the particulate sample is measured. According to some embodiments, the fluid imbibed into the interior of the sample is aqueous, including mixtures. According to some other embodiments, the fluid imbibed into the interior of the sample is a non-aqueous fluid. According to some other embodiments the fluid imbibed is a solution of miscible solvents. The technique used to measure the imbibed fluid depends on the solvent (imbibing fluid) being studied. In an embodiment of the method, this technique includes both gravimetric determination and quantitative chemical analysis. Advantageously, the detection of water is via Karl Fischer titration. The imbibition test can include an estimate of wettability and/or contact angle of the sample and the treatment fluid or an additive.

According to some embodiments counter-current rate data are used to determine pore-level wettability. According to one embodiment a surfactant is used. If there is no change when compared to when pure water was used, the surfactant was unable to enter the small pores typical of shales.

As used herein the term “shale” refers to mudstones, siltstones, limey mudstones, and/or any fine grain reservoir where the matrix permeability is in the nanodarcy to microdarcy range.

As used herein the term “gas” means a collection of primarily hydrocarbon molecules without a definite shape or volume that are in more or less random motion, have relatively low density and viscosity, will expand and contract greatly with changes in temperature or pressure, and will diffuse readily, spreading apart in order to homogeneously distribute itself throughout any container.

As used herein the term “oil” means any naturally occurring, flammable or combustible liquid found in rock formations, typically consisting of mixture of hydrocarbons of various molecular weights plus other organic compounds such as is defined as any hydrocarbon, including for example petroleum, gas, kerogen, paraffins, asphaltenes, and condensate.

As used herein the term “condensate” means a low-density mixture of primarily hydrocarbon liquids that are present as gaseous components in raw natural gas and condense out of the raw gas when the temperature is reduced to below the hydrocarbon dew point temperature of the raw gas.

### BRIEF DESCRIPTION OF THE FIGURES

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 represents a schematic illustration of the formation of natural and artificial micro fractures in a plug recovered during a coring operation;

FIG. 2 represents a schematic illustration of phase trapping;

FIG. 3 is a graph presenting results from a typical experiment where two distinct imbibition events are observed, according to some embodiments;

FIG. 4 presents typical results showing how the saturation at the closed end of a typical porous medium increases with time during counter-current imbibition, according to some embodiments;

FIG. 5 is graph presenting the mass gained results from the model assuming two different contact angles, according to some embodiments;

FIG. 6 is a graph showing the result when the real-time data shown in FIG. 5 are plotted vs. a dimensionless time group that incorporates the contact angle, according to some embodiments; and

FIG. 7 is a flow chart showing steps in carrying out imbibition analysis on rock samples, according to some embodiments.

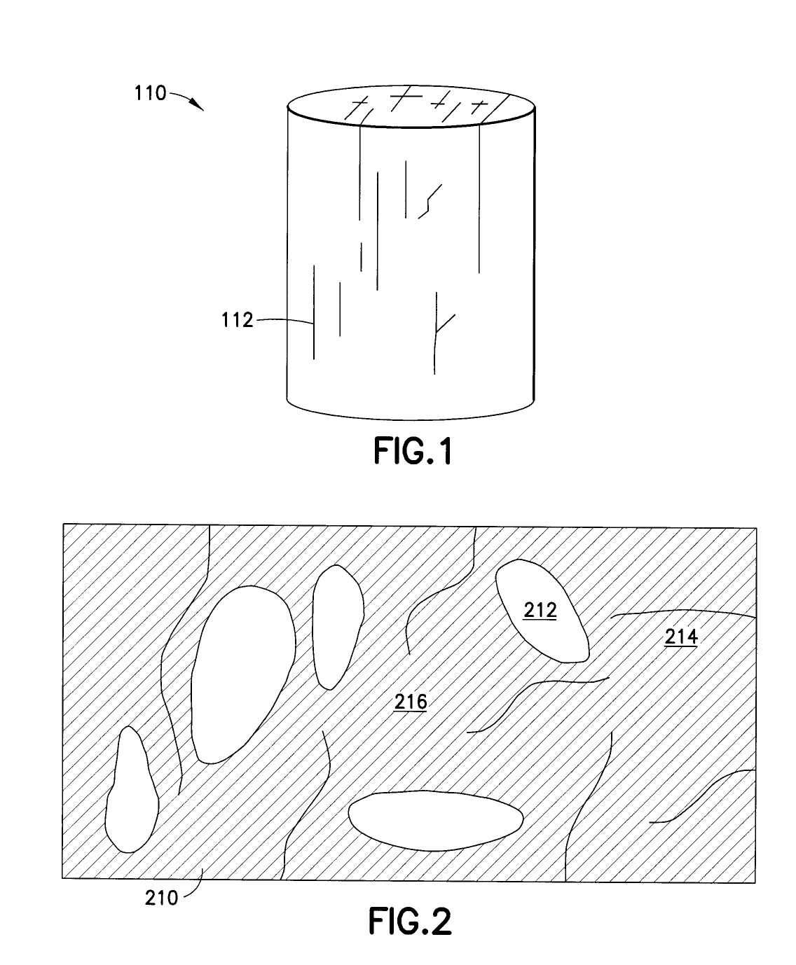

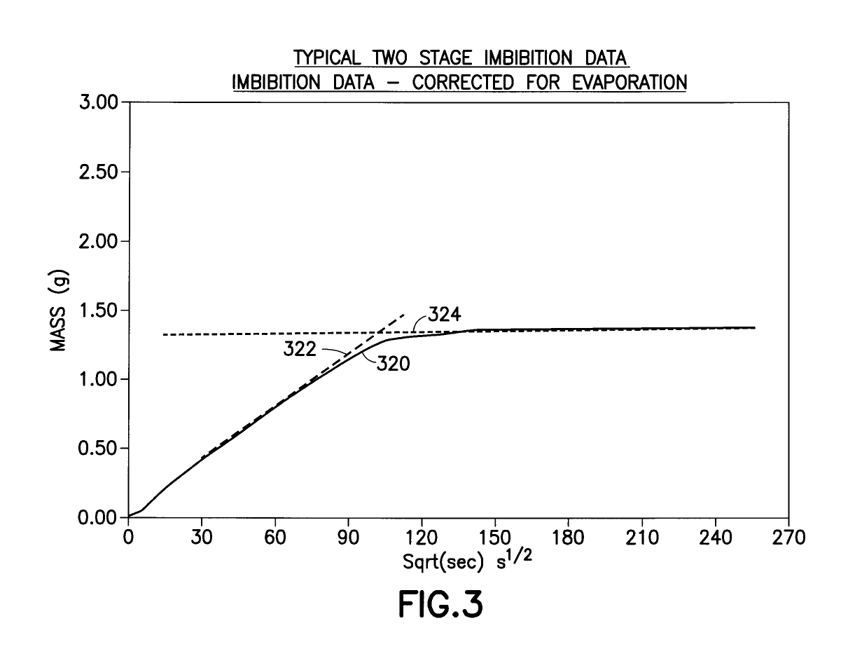

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Shale reservoirs throughout the world are known to contain enormous quantities of gas and liquid hydrocarbons, but the production mechanisms operative in these reservoirs are poorly understood. Until fairly recently, the wettability of gas reservoirs has not been of much concern. With the exploitation of gas reserves in coal seams and shale, the so-called unconventional reservoirs, the question of wettability takes on greater importance. The development of methods to efficiently recover gas from shale benefits from a good understanding of the chemical nature of the shale. Any exploitation of the shale reserves will likely require the introduction of a fluid into the reservoir; how that fluid interacts with the formation depends on the extent to which the fluid wets the formation.

It is believed that many of the techniques described herein can practically be applied to reservoirs having low matrix permeability (i.e. between 100 nanodarcies (nD) and 500 mD, where 1D=9.87×10⁻¹³ m²).

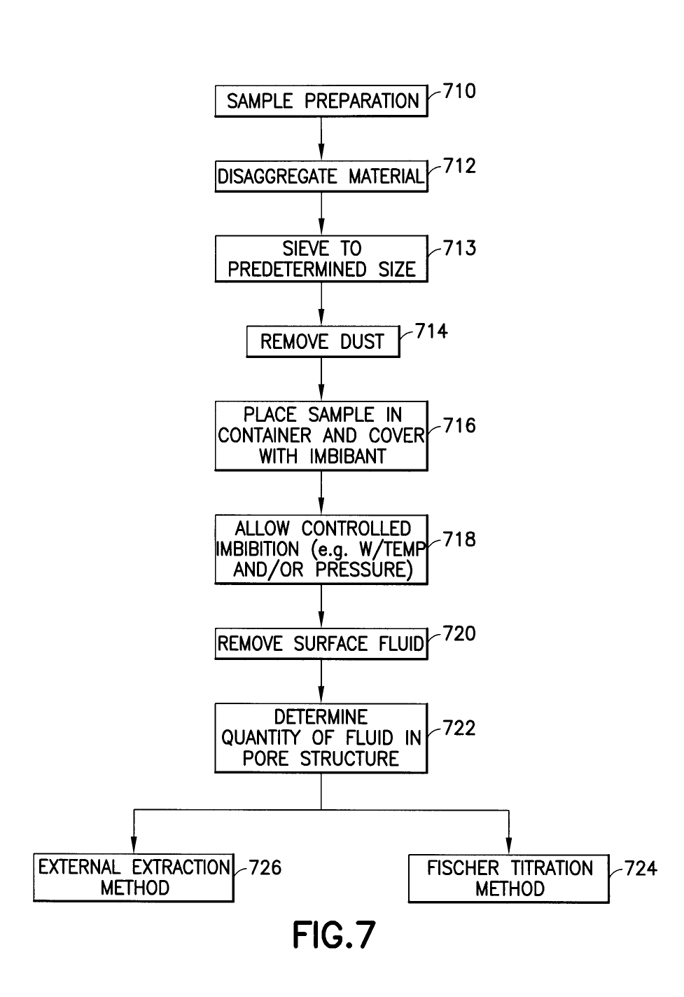

FIG. 7 is a flow chart showing steps in carrying out imbibition analysis on rock samples, according to some embodiments.

Sample Preparation. In step 710, a careful preparation step is provided for the core sample. In examples wherein the imbibed test will use water, it is very important to choose the right sample for the water content determination. For example, if one wishes to accurately measure the water content of the “as received” material, the sample preferably should not be dried out due to inappropriate handling or prolonged storage in suboptimal conditions, e.g. unsealed containers in a hot, dry warehouse. On the other hand, it should be ensured that the sample is not permeated with drilling fluid or other fluids like cooling agent during cutting of core material.

Sample Comminution. According to some embodiments, the sample is disaggregated, in an optional but preferred step 712, the measurements are carried out on a sample of disaggregated material taken from the core, rather than on the whole core. According to some embodiments, using a disaggregated material versus whole core has been found to be advantageous for a number reasons. The availability of whole core is very limited. Furthermore, the ultra-low matrix permeability often found in unconventional reservoirs such as shale, for example, having a matrix permeability well below 0.1 mD would require that test times be very long, or that very large samples be used. Disaggregation has been found to be a convenient means to increase the surface are available to imbibition thereby greatly speeding up the test.

A potential problem associated with imbibition testing using ultra-low permeability whole core is the far greater likelihood of phase trapping during a test. In the absence of specialized surfactants, phase trapping hinders the imbibition process. There is far greater uncertainty regarding the porosity and permeability of the core, whereas these properties are easily measured as a part of every test conducted using packs of disaggregated material. While pack properties can be relatively accurately and easily measured, knowledge of the matrix permeability and porosity is significantly more difficult to obtain. Matrix permeability and porosity are very useful and in many cases necessary to analyze imbibition rate data to estimate wettability. Virtually all shale cores exhibit a significant number of natural fractures and the permeability measured using these cores is therefore a weighted average of the permeability due to fractures, the filled or mineralized natural fractures (veins) and the matrix permeability; analysis of flow through such a system is complex. Furthermore, the induced fractures due to depressurization and mechanical shocks during the coring process will imprint an artificial overprint on the permeability of the whole core. Matrix permeability and porosity can be measured more accurately on the disaggregated material.

According to some preferred embodiments, in step 712, suitable core material is therefore crushed with a jaw crusher or mill and then in step 713, sieved into the desired size fractions. This process preferably is carried out in a timely fashion in order not to dry out the sample. The particle size may be different depending on the analysis method used. For example, the particle size for a test using a pack may be different than for a test where Karl Fischer titration method is used.

It is believed that the grinding of the core has only minor impact on the surface properties of the material. While the process of grinding alters the reservoir material physically, the fresh surfaces that result from grinding are believed to be quite representative of the chemical nature of the formation in its natural state. Furthermore, the surfaces of samples shaped by drilling or sawing using either oil or water lubricants do not accurately reflect in-situ properties.

The weight fractions are then stored in sealed, airtight containers. Usually the crushed material, even when sieved, still contains large amounts of dust adhering to the particle surface. In step 714, dust is removed. In order to remove the dust, the sample can be washed in a Buchner funnel by quickly rinsing with a fixed amount of water. Then immediately the sample is rinsed with a fixed amount of methanol to get rid of surface water. If this process is performed fast enough (5-15 seconds), no significant imbibition takes place and the methanol evaporates quickly to leave the dry, relatively dust free sample to be sealed into airtight containers. Another method to remove dust from a sized sample is by application of a gas stream, e.g. dry compressed air, nitrogen or similar. The sample can be placed in a sieve like assembly that comprises a lid with an opening for the gas stream opposite the sieve mesh. When the gas stream blows across the sample the dust is driven out of the sieve. A third method of removing dust is by careful tumbling of the particles in a vacuum chamber.

Controlled Imbibition. In step 716, a weighed amount of the sample is placed into a container and covered with the imbibant. In step 718, after the container is sealed it can be placed into an oven at elevated temperature that does not exceed the boiling point of the fluid. Alternatively, the sample can be placed into a pressure vessel. The vessel is then completely filled with imbibant and sealed. Subsequently, the vessel can be heated and pressurized to reservoir conditions. After a predetermined soaking time—nominally between 2 hours and 72 hours, the vessel is cooled and depressurized.

Removal of the Surface Film of Fluid. Separation of surface moisture from matrix saturation important. In step 720, the surface film of fluid is removed. According a preferred embodiment, the mass of fluid that is adsorbed onto the surface of the sample particles is differentiated from the mass of fluid that is imbibed into these particles.

After the soaking period the sample is separated from the imbibant in a Buchner funnel. As the surface of the sample particles is still wet, an immediate titration would result in a water content that is too high. Therefore, the sample needs to be dried at the surface without loss of water from within the sample particles. Various embodiments are proposed to achieve this.

In a first embodiment, the sample can be spread in a Petri dish and left to air dry or placed in an oven with a slightly elevated temperature, e.g. 50° C., in order to speed up the air drying process. This method has the drawback, that it does not have a defined end point. There may be parts of the sample that are still wet on the outside while other particles are already loosing imbibed water to the atmosphere. Also this process might difficult to automate. The drying time depends heavily on the relative humidity of the surrounding environment and can change on a daily basis. The endpoint of the drying time may be determined by the sample “looking” dry or by the particles not sticking together anymore. When identical samples surface dried with this method are titrated, large variations of water content can be found.

In a second embodiment, the sample can be placed into a specially designed centrifuge filtering assembly and the surface water spun out at high velocity. The centrifuge filtering assembly consists of two centrifuge tubes placed into each other. The outer larger tube will trap any out-flowing fluid and contains a small hole at the top to allow for pressure equilibration. The lid of the larger tube has a hole that precisely fits the smaller tube and functions as a ledge to hold the smaller tube in place. The inner smaller tube comprises a lid, a perforated support, a filtering wire mesh and a fluid outlet. The lid serves as a ledge to keep the smaller tube in place. When assembled it sits on top of the lid of the outer tube. The support is positioned at the top of the tapered section of the inner tube and is perforated with several holes large enough for the unhindered flow of fluid through the support. The perforations can be larger than the sample particles. On top of the support is a filter medium, which holds the sample in place while spinning. The filter medium can be made of paper, polymers or a wire mesh with pore sizes smaller than the sample particles. The tubes and lids can be made of plastic, glass or metal. The advantage of the centrifuge filter assembly is that the sample can be soaked in the inner tube provided it does not need to be exposed to reservoir temperatures or pressures. This minimizes sample handling and loss of material due to suboptimal sample transfer. Another advantage of the centrifugal surface drying method is the fact that the rotational speed can be adjusted to be fast enough to drain the surface water, but to be not fast enough to overcome the capillary pressure of the particle pores therefore, not spinning out fluid imbibed into the sample particles.

In a third embodiment, the soaked particles can be quickly washed with a suitable solvent, e.g. methanol, glycol, glycerol or similar, while still in the Buchner funnel (or squeezed out through a syringe). When this washing step is performed with a fixed small amount of dry solvent the surface water is washed away and replaced by the solvent. This must be done quickly (10-15 seconds) in order to not draw imbibed water out of the particle pores with the solvent. The solvent-wet particles can directly be placed into either the Karl Fischer oven or the extraction solution as described below. Measurements have shown the results of this solvent washing step to be very consistent and accurate. The advantage of this surface drying method is the simplicity and speed.

In step 722, a quantitative detection of the Fluid in the pore structure is made. According to some embodiments a Fischer titration method is used. Once the imbibed sample is surface dry it can be placed into a Karl Fischer oven (or tube furnace). This is a tube oven that is connected to an automatic titrator. The oven needs to be preheated to a given temperature that is suitable to drive out water contained in the sample without initiating secondary chemical reactions. Dry inert gas needs to be streamed through the hot oven in order to make sure that no moisture is present in the system prior to adding the sample. An amount of sample is weighed and placed into the hot oven. A fixed amount of dry, inert gas is streamed over the sample and into the solvent in the titrator. Any evaporating water from the sample is taken up by the gas stream and directly transferred into the solvent. Once the evaporation process is complete the solvent is titrated according to the Karl Fischer method as described above. The resulting water content is then normalized to one gram of sample material in order to make results for various samples comparable. When the effective porosity is known for the sample, for example by measuring by mercury injection or other experimental methods, the water saturation can be calculated. It is to be noted that in the case the imbibed fluid is not water but non-aqueous solvent, another appropriate titration method or other detection method will be used (for example, Gas Chromatography for hydrocarbons/chlorinated solvents).

Another method to liberate water (or the imbibed fluid) contained in the sample is the so-called external extraction. In step 726, the sample—either native or imbibed—is placed into a container and filled with an anhydrous hygroscopic solvent, e.g. methanol. Usually, a ten-fold amount of solvent compared to sample mass is used. Driven by chemical potential gradient, the methanol diffuses into the pores of the sample particles and removes the water contained within. Water also diffuses out due to the chemical potential gradient. This process can be enhanced by increasing the temperature or by sonicating the sample and the solvent.

Conical-bottom centrifuge tubes have proven to be useful as containers as these can be plugged by sleeve stoppers made of rubber or silicone. This has the advantage that the sample is sealed from the environment and the hygroscopic methanol does not take up atmospheric water during the extraction. The sample container does not need to be opened but a sample can be transferred to the titration beaker via a syringe through the septum or other inert gas techniques. After a fixed time an aliquot of the solvent is syringed into the titration beaker and titrated after the Fischer method.

When using a syringe to transfer a sample form the extraction container to the titrator, the pressure balance can be achieved by an air-drying assembly. For example, this consists of a plastic syringe tube which has been filled with a layer of activated molecular sieve, a small layer of Drierite and another layer of molecular sieve. The syringe tube is then sealed with a sleeve stopper. The layer of Drierite functions as an indicator for moisture in the syringe tube. When the Drierite changes colour the capacity of the molecular sieve to take up moisture is exhausted and it needs to be reactivated. When the air-drying assembly is used one Luer syringe needle is connected to the syringe tip and one is pushed through the septum at the top end.

The needle at the tip is then pushed through the septum of the extraction container. When sample is taken out of the extraction container with a syringe, the gas pressure in the container is reduced. To compensate this pressure drop, air flows through the drying assembly into the extraction container. As the air needs to pass the activated molecular sieve beds, the moisture in the air is absorbed and only dry air will enter the extraction container.

This method can be employed via a number of embodiments. Of particular interest is this method can be used either in a time dependent or time independent manner. In a time dependent embodiment—the imbibition is measured as a function of time. In this embodiment a larger sample of material is quantitative split into a number of parallel smaller portions. Each of these portions is independently exposed to the test fluid under identical conditions, but each sample is exposed for a different length of time. The results from the total set of measurements can be combined to create a time dependent curve. As discussed later, this information can be used to determine the wetting behavior of the rock.

Alternatively the method can be used to determine total imbibition of the fluid into the rock. That is, the imbibition experiment is run for a given combination of rock sample and test fluid until imbibition is complete and there is no additional uptake of the test fluid into the rock. By comparing the total uptake of water into the rock, one can determine how much of the pore volume will be invaded by the imbibing fluid. This test method is useful for evaluating whether a rock sample will be prone to water uptake.

Recent petrological studies have shown that shales and mudstones contact a number of different classes of pore structures. See, Milner, M., McLin, R., Petriello, J. SPE 138975, 2010. These pores are formed by different depositional and diagenetic processes. Some of these pores are completely lined with kerogen, some are completely enveloped by inorganic minerals. Of particular interest is that these pores will have different surface energies, and therefore different wetting characteristics. Therefore, the sample can contain pores that are completely hydrophobic, and pores that are extremely hydrophilic in the same small region of the rock. Methods that would allow one to measure the distribution of hydrophilic and/or hydrophobic pores in a sample—or the net effects of this distribution would be particularly useful.

By performing a series of imbibition measurements with a homologous series of solvents with varying surface tensions one can determine not only the average wetting condition of the rock, but the distribution of surface energies in the rock. An example of a suitable solvent series for this test would be series of water/methanol solutions. As the methanol concentration increases the surface tension of the solvent drops markedly. Only the high energy surfaces in the rock will be wet by pure water. As the methanol concentration is increased, more and more of the total pore surface area can be wetted by the lower and lower interfacial tension solvents. The total imbibition embodiments described herein can be used to measure the imbibition as a function of fluid surface tension. This is analogous to the Zisman method of determine the surface energy of a given material. This series of tests could be used to show that the contact angle decreases as the surface tension decreases. We should also see that the total saturation of imbibant increases as surface tension decreases. The rate of imbibition may decrease as surface tension decreases, as well. See, Fox, H. W. and Zisman, W. A., “The spreading of liquids on low-energy surfaces. II. Modified tetrafluoroethylene polymers, J. Colloid Science, 7 (1952) 109-121, and co-pending U.S. patent application Ser. No. 12/974,116, entitled “WETTABILITY ANALYSIS OF DIS AGGREGATED MATERIAL”, filed on Dec. 21, 2010 which is incorporated by reference herein.

In order to determine the rate of imbibition a sample is split into several sub samples. The sub-samples are placed into separate containers that are then filled with the respective imbibant. After a certain time period of predetermined length the first sample is separated from the imbibant to stop the imbibition and processed as described above. After another time interval the next sample is processed. The time series is continued until all samples have been processed. The time interval can be of the same length each time or it can vary in length.

Determining the imbibant content in the samples allows calculating an imbibition rate as well as an imbibition capacity per mass or volume of rock.

According to some embodiments, in cases where there is a reference material of similar permeability and porosity whose wettability is already known, a qualitative assumption on the wettability of the material can be made by applying cut-off criteria to the imbibition rate of water. A fast imbibing material is hydrophilic, whereas a slowly imbibing sample is of mixed wettability, and a material that does not imbibe is hydrophobic.

A method to determine a counter-current imbibition rate is the use of a series of small sample plugs. These are placed into confining sleeves so that one end is left open, both ends are open, or both ends are closed and the sides are open. The leaving one end open boundary condition assures counter-current flow. Any boundary condition can be used as there are well-defined methods for determining the characteristic length. This sleeve can be for example a rubber tube, a Teflon wrap or a wax coating, but not limited to these. Then the samples are exposed to imbibant at one open end. As above the samples are separated from the imbibant after predetermined time periods. Then a layer of a fixed depth of material from the sample plug is mechanically removed and the imbibant content determined in the removed material as described above. Then another layer is removed and analyzed. This is repeated until the imbibant saturation is either zero or at the initial pre-imbibition level. According to some embodiments, the layer removal steps are performed all at once with the layers saved for future analysis. This way the potential for continuing fluid movement is not an issue. A CT scan can provide similar data.

By doing the process described above, a saturation depth profile can be composed for the plug. When this procedure is repeated with a series of plugs that have been left in contact with the imbibant for different time periods, a counter-current imbibition rate can be calculated. Note that in many cases only counter-current flow exists in a fracture reservoir setting and in many experiments. Boundary conditions should be established, e.g. one end open, to assure that counter-current flow is being achieved.

When the controlled imbibition as described above is done on a series of samples with a series of imbibants that consist of a mixture of fluids (e.g. water/methanol) with varying surface tensions, a plot of the imbibant saturation vs the surface tension can be composed. The resulting curve will have a characteristic shape that reflects the wettability of the matrix. Comparing (either qualitatively visual or via a curve fitting equation) the resulting curve to corresponding curves of porous media with known wettability, i.e. contact angles, the wettability/contact angle for the material under investigation can be deduced.

According to some embodiments, provided methods are straight-forward, inexpensive, and make use of only small samples from the reservoir, rather than whole cores.

The method of the invention is particularly advantageous for rock samples having low permeability. It is believed that many of the techniques described herein can practically be applied to any samples having low matrix permeability (i.e. between 10 nanoDarcies (nD) and 500 mD, where 1D=9.87×10⁻¹³ m²).

For gas and/or supercritical fluid producing wells, some embodiments are particularly advantageous when the matrix permeability is less than 1 mD, even more advantageous when the matrix permeability is less than 0.5 mD, even more advantageous when the matrix permeability is less than 0.1 mD, and most advantageous when the matrix permeability is less than 0.01 mD. Some embodiments are particularly advantageous when the matrix permeability is in the nanoDarcy range. For oil and/or condensate producing wells, some embodiments are particularly advantageous when the matrix permeability is less than 10 mD, even more advantageous when the matrix permeability is less than 5 mD, even more advantageous when the matrix permeability is less than 1 mD, and most advantageous when the matrix permeability is less than 0.1 mD.

It should be noted that although the embodiments have been described with respect to recovery of hydrocarbon from a source formation, according to some embodiments techniques described herein are also applied to a source that is obtained via mining operations, e.g., surface mining or subsurface mining, especially in the case of coal seams (coalbed methane). For example, material obtained from surface mining could be treated with fluid to recover or remove hydrocarbon from the material. According to some embodiments, techniques described herein are also applied to remove pollutants from groundwater.

Further detail will now be provided with respect to determining wettability from imbibition data, according to some embodiments.

A 1-D Model for Predicting and Analyzing Counter-current Flow. Handy, L. L., “Determination of Effective Capillary Pressures for Porous Media from Imbibition Data”, Petroleum Transactions, AIME, Vol. 219 (1960) (hereinafter “Handy”) provided one of the earliest treatments of counter-current flow for a water-air-rock system. Handy formulated the following expression:

$$φ \frac{\partial {S}_{w}}{\partial t} = - \frac{\partial }{\partial x} [ ( \frac{{k}_{w}}{{μ}_{w}} \frac{\partial {P}_{c}}{\partial {S}_{w}} ) \frac{\partial {S}_{w}}{\partial x} ] \qquad Eqtn . 1$$

In Eqtn. 1, is the porosity (fraction), S_{w} is the wetting phase saturation (fraction), k_{W} is the permeability to the wetting phase (cm²), μ_{w} is the viscosity of the wetting fluid (dynes-s/cm²), P_{c} is the capillary pressure (dynes/cm²), x is the distance (cm) and t is time (s). Handy noted that Eqtn. 1 is the one-dimensional diffusion equation with

$$- \frac{{k}_{w}}{{μ}_{w}} \frac{\partial {P}_{c}}{\partial {S}_{w}} = D \qquad Eqtn . 2$$

Rangel-German, E. R. and Kovscek, A. R., “Water Infiltration in Fractured Systems: Experiments and Analytical Model”, SPE 71618 (2001) (hereinafter “Rangel-German et al.”) provides some interesting results that relate directly to experiments where a fluid imbibes sequentially into a pack and then into the particles forming the pack. The work is related to the expulsion of air from porous media by spontaneous imbibition of water and the authors used CT-scans to track saturations. The authors identified two regimes that they referred to as “Filling-Fracture” and “Instantly-Filled”.

We are more concerned with the results related to the “Instantly-Filled” case. In this case, fluid advances to submerge a matrix element before significant matrix imbibition has begun. In the case of our experiments, instant immersion of particles would clearly be equivalent. It may also be argued that the secondary, i.e. intra-particle, imbibition observed in pack studies is, in fact, represented by the “Instantly-Filled” fracture case.

Rangel-German et al. present an analytical matrix-fracture transfer function that may be used to model the process where particles, or matrix blocks, are more or less instantly submerged:

$${S}_{w} ( z , t ) = erfc ( \frac{z}{2 \sqrt{\frac{{α}_{h}}{φ} t}} ) \qquad Eqtn . 4$$

where

$${α}_{h} = - \frac{{k}_{w}}{{μ}_{w}} \frac{d {P}_{c}}{d {S}_{w}} \qquad Eqtn . 5$$

Obviously, Eqtn. 2 and Eqtn. 5 are identical when αₕ is equal to D. In Eqtn. 4, z represents distance in cm and is the same as x in Eqtn. 1. Eqtn. 4 is the classical solution to the diffusion equation.

Reference to Eqtn. 1 and 2 shows that, in addition to knowledge of the formation permeability and porosity, we need to know how the capillary pressure changes with respect to saturation. Fortunately, Handy, and Babadagli, T. and Hatiboglu, C. U., “Analysis of counter-current gas-water imbibition transfer functions at different temperatures”, J. Pet. Science and Engineering, 55 (2007) 277-293 (hereinafter “Babadagli et al.”) provide guidance here.

$${Q}^{2} = ( \frac{2 {P}_{c , eff} {k}_{w} φ {A}^{2} {S}_{w}}{{μ}_{w}} ) t \qquad Eqtn . 6$$

Eqtn. 6 shows that the square of the flow rate of imbibant into a porous medium will be proportional to time. The volumetric flow rate is easily converted to a mass flow rate and vice versa.

We use Eqtn. 6 to determine how the effective capillary pressure changes with saturation

$$\frac{\partial {P}_{c , eff}}{\partial {S}_{w}} = - \frac{m {μ}_{w}}{2 {k}_{w} φ {A}^{2} {S}_{w}^{2}} \qquad Eqtn . 7$$

where

$$\begin{matrix}m = \frac{2 {P}_{c , eff} {k}_{w} φ {A}^{2} {S}_{w}}{{μ}_{w}} & Eqtn . 8 \\ {α}_{h} = - \frac{{k}_{w}}{{μ}_{w}} \frac{d {P}_{c , eff}}{d {S}_{w}} = - \frac{{k}_{w}}{{μ}_{w}} ( - \frac{m {μ}_{w}}{2 {k}_{w} φ {A}^{2} {S}_{w}^{2}} ) = \frac{m}{2 φ {A}^{2} {S}_{w}^{2}} & Eqtn . 9\end{matrix}$$

Substituting Eqtn. 9 into Eqtn. 4

$${S}_{w} ( z , t ) = erfc ( \frac{z}{2 \sqrt{\frac{{α}_{h}}{φ} t}} ) = erfc ( \frac{zA φ {S}_{w , eq}}{\sqrt{2 mt}} ) . \qquad Eqtn . 10$$

The appearance of S_{w,eq} in the argument of the complementary error function bears further explanation. Since during counter-current flow, equal volumes of the wetting and non-wetting fluids are moving in opposite directions, the net volumetric flux is zero. In other words, the wetting and non-wetting fluids have equal mobility.

Consider the relative permeability curves of the two fluids and convert those curves into relative mobility curves, i.e. adjust the two curves by dividing the relative permeability of a fluid by its viscosity. The curves will exhibit equal mobility at only one saturation. This saturation value is the final, equilibrium saturation and is a constant determined by laboratory measurement. The equilibrium wetting phase saturation can also be directly related to the ultimate recovery of non-wetting fluid.

If we set a boundary condition that the saturation at z=0 is equal to the equilibrium saturation, then Eqtn. 10 becomes

$${S}_{w} ( z , t ) = {S}_{w , eq} erfc ( \frac{zA φ {S}_{w , eq}}{\sqrt{2 mt}} ) \qquad Eqtn . 11$$

So, using Eqtn. 11 with two pieces of information from a matrix imbibition test, S_{w,eq} and m, we can develop a curve that represents counter-current flow into a medium with a OEO boundary condition.

Adapting the 1-D Model to an Ensemble of Particles. When modeling imbibition into an assembly of particles, we must use the total surface area of the material exposed to the imbibant. For purposes of simulation using the simple model previously described, we assume that the particles have been reconstituted into a large wafer. Knowing the surface area of the particles exposed to the imbibant and the mass of the particles, we can compute how long the reconstituted specimen will be. The permeability and porosity of the synthetic sample will be the same as the permeability and porosity of the matrix.

The specific area of a porous medium is the interstitial area, so it is that portion of the medium actually contacted by a fluid residing in or flowing through the medium. We will focus our discussion on packs. Carman, P. C., Fluid flow through a granular bed. Trans. Inst. Chem. Eng. London, 1937. 15: p. 150-156; Carman, P. C., The determination of the specific surface of Powders. I. J. Soc. Chem. Ind., 1938. 57: p. 225-234; Kozeny, J., Uber kapillare Leitung des Wassers im Boden, Sitzungsber. Akad. Wiss., 1927, 136, p. 271-306; and Kozeny, J., Hydraulic, Springer, Vienna, 1953 (collectively referred to hereinafter as “Carman-Kozeny”) provides a relationship that correlates the wetted surface area to permeability and porosity. The permeability and the porosity of every pack are determined prior to an imbibition experiment.

$${S}_{v} = \sqrt{\frac{6 {φ}_{p}^{3}}{25 {k}_{p}}} {cm}^{2} \text{/} {cm}^{3} ( wetted area / unit of bulk volume ) \qquad Eqtn . 12$$

In Eqtn. 12, we have used the subscript p to distinguish pack porosity and permeability from matrix properties. Substituting the values measured for a typical pack—see Table 1.

$${S}_{v} = \sqrt{\frac{6 {( 0.4 )}^{3}}{25 ( 30 ) 9.87 \times {10}^{- 12}}} = 7202 {cm}^{2} \text{/} {cm}^{3} \qquad Eqtn . 13$$

(For reference, Carman, P. C., J. Soc. Chem. Ind., 57 (1938) 225 reports values for silica powder ranging from 6800-8900 cm²/cm³ with porosity ranging from 0.37-0.49 and permeability ranging from 13-51 mD.)

For purposes of simulation, we assume that the wetted area exposed to the imbibant is given by Eqtn. 12, we then reassemble the particles into a medium with the permeability and porosity equal to that of the matrix—we will call the synthetic sample the OEO Sample. For the case at hand, we would have a wafer with the area of the face exposed to imbibant equal to 1.33×10⁴ cm² and a length equal to 1.67×10⁻⁴ cm—see Table 1. It should be noted that the model could also be used to represent imbibition into the face of a fracture.

TABLE 1
Summary of the Properties of the Pack and the Synthetic Medium

| | Perme- | | Specific | | | | |
|---|---|---|---|---|---|---|---|
| | ability | Porosity | Gravity | Length | Area | Slope | S_{w, eq} |
| Sample | (md) | (fraction) | (g/cm³) | (cm) | (cm²) | g/s^{1/2} | (fraction) |
| Pack | 30 | 0.40 | 2.65 | 2.46 | 0.75 | 1.32 × 10⁻² | 1.0 |
| OEO | 80 × 10⁻⁶ | 0.05 | 2.65 | 1.67 × 10⁻⁴ | 1.33 × 10⁴ | 5.74 × 10⁻⁴ | 0.8 |
| Sample | | | | | | | |

As shown in Table 1, the specific area of a pack typical of those used in our experiments is very large, and this once again makes the case for using comminuted formation samples in order to expeditiously study imbibition into ultra-low permeability media.

FIG. 3 is a graph presenting results from a typical experiment where two distinct imbibition events are observed, according to some embodiments. Curve 320 represents imbibed mass. Also shown are two events, the first event occurs at early time and it represents imbibition into the pack, i.e. inter-particle imbibition, at a rate shown by line 322. The second event occurs later and it represents imbibition into the particles themselves, intra-particle imbibition, at a rate shown by line 324.

The slopes measured for the two imbibition cases are used as input into Eqtn. 11. The equilibrium saturations for the pack and the particles are also required input and we have arbitrarily assumed S_{w,eq}=0.8 and 1.0 for the synthetic matrix and pack respectively. However, in practice these values would come from a laboratory measurement.

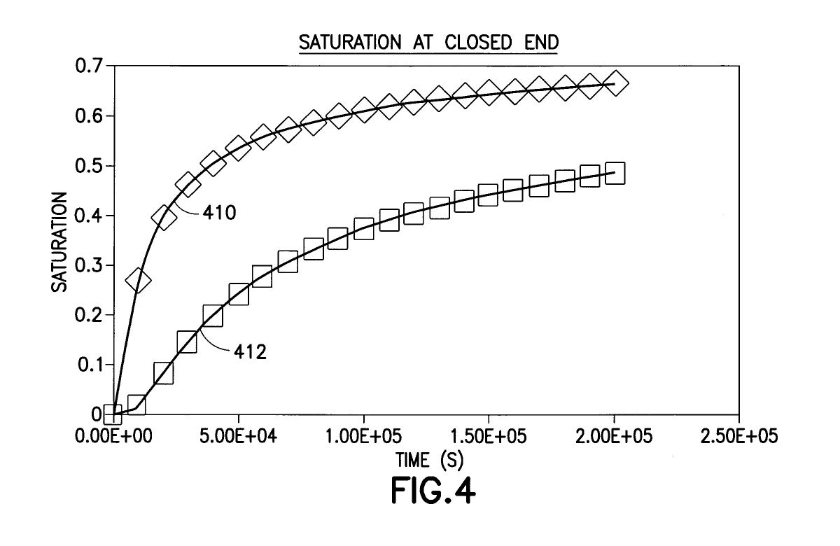

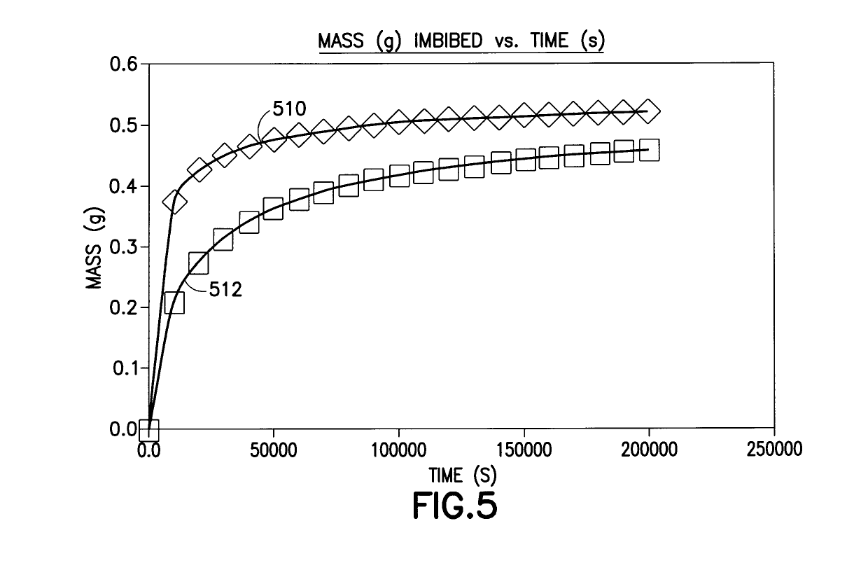

Eqtn. 11 allows us to calculate the saturation at any given time and at any position. FIG. 4 presents typical results showing how the saturation at the closed end of a synthetic medium increases with time, according to some embodiments. While a CT-scan might provide such data as shown in FIG. 4, we only have mass data available from our experiments, but it is easy to convert saturation data into mass-gained data.

The data shown in FIG. 4 were generated using the 1-D model and the properties of the OEO Sample shown in Table 1. For purposes of illustration, it is assumed that the base case data shown in FIG. 3 were from a perfectly water-wet specimen, and we will refer to this case as the ‘known.’ We then assume that the contact angle for an ‘unknown’ sample was 80°. The result for 0° is shown in curve 410, and the result for 80° is shown in curve 412.

FIG. 5 is graph presenting the mass gained results from the model assuming two different contact angles, according to some embodiments. The result for 0° is shown in curve 510, and the result for 80° is shown in curve 512. As expected, the 0° 510 curve is quite different from the 80° curve 512, and the 0° curve shows more rapid imbibition.

How Data May Be Evaluated Using Dimensionless Time. A number of researchers have used dimensionless groups to compare, correlate and analyze imbibition data. See, Babadagli et al.; Gupta, A. and Civan, F., “An Improved Model for Laboratory Measurement of Matrix to Fracture Transfer Function Parameters in Immiscible Displacement”, SPE 28929 (1994) (hereinafter “Gupta and Civan”); Ma, S., Morrow, N. R. and Zhang, X., “Generalized Scaling of Spontaneous Imbibition Data for Strongly Water-wet Systems”, Pet. CIM, 95-138, 1995 (hereinafter “Ma et al.”); Behbahani, H. S., Di Donato, G. and Blunt, M., “Simulation of counter-current imbibition in water-wet fractured reservoirs”, J. Petroleum Science and Engineering, 50 (2006) 21-39 (hereafter “Behbahani et al.”); and Fischer, H., Wo, S. and Morrow, N. R., “Modeling the Effect of Viscosity Ratio on Spontaneous Imbibition”, SPE 102641 (2006) (hereinafter Fischer et al.). Scaling functions have been developed that allow comparison of data from tests where sample size, shape, boundary conditions and fluid properties were different.

Gupta and Civan present an interesting matrix-to-fracture transfer model and they applied their model to their own imbibition data as well as to previously published results with good success. The authors found significantly improved fits when they included contribution from dead-end storage pores and wettability information in the form of the contact angle. This is one of the first studies to incorporate wettability explicitly into the dimensionless time group and doing so significantly improved the overall agreement between their model and available data. Ma et al. also recognized the importance of wettability and attempted to characterize wettability using imbibition experiments.

Babadagli et al. evaluated a number of dimensionless time groups and found that only two were worthy of further consideration when applied to the water-air-rock system they studied. In fact, there is only one dimensionless time group that seems to provide consistently good scaling of counter-current flow data and this group will be identified later in this report.

Behbahani et al. and Fischer et al. have provided some excellent theoretical support. Behbahani et al., through the use of a simulator, showed that the scaling groups proposed by Ma et al. are quite good. Fischer et al. also showed that the scaling groups proposed by Ma et al. are generally quite effective for correlating diverse data sets.

The dimensionless time group that appears to be most successful is given by Fischer et al. as

$${t}_{D} = t \sqrt{\frac{k}{φ}} \frac{σ}{\sqrt{{μ}_{o} {μ}_{w}}} \frac{1}{{L}_{c}^{2}} \qquad Eqtn . 14$$

In Eqtn. 14, t is time in seconds, k is permeability in cm², is porosity as a fraction, σ is surface tension in dynes/cm, μₒ and μ_{w} are the viscosities of the non-wetting and wetting phases respectively in dynes-s/cm², and L_{c} is the characteristic length in cm which is determined by sample size and sample geometry. Table 2 presents formulae for computing the characteristic lengths once sample shape and boundary conditions are known.

TABLE 2
Characteristic Length, L_{c}

| Boundary Condition | Flow Regime | Characteristic Length, L_{c} |
|---|---|---|
| One End Open (OEO) | Linear | l |
| Two Ends Closed (TEC) | Radial (2D) | $\frac{d}{2 \sqrt{2}}$ |
| Cylindrical All Faces Open (AFO) | Complex | $\frac{ld}{2 \sqrt{{d}^{2} + 2 {l}^{2}}}$ |
| Sphere | Radial (3D) | $\frac{d}{2 \sqrt{3}}$ |

Note that the first boundary condition may be used for either a right parallelepiped or a cylindrical; specimen; l is the length of the sample. The first three boundary conditions may be used for cylindrical samples where l is sample length and d is the diameter. For spherical samples, the fourth expression must be used; d is the diameter of the sphere.

Eqtn. 14 uses the geometric mean of the non-wetting and wetting fluid viscosities and, though this relationship is empirical in nature, a number of authors, particularly Babadagli et al. focusing on the water-air-rock case, have found that this group provides superior scaling. Given that the use of the geometric mean of the fluid viscosities is well accepted, we see no reason to deviate from that practice.

Most studies have assumed that the matrix is strongly water-wet. Ma et al. recognized that formations that were not strongly water-wet would behave differently and suggested that deviation from expected results was likely due to imperfect wetting. There is no reason to assume perfect wetting and, as proposed by Gupta et al., we introduce wettability by including the contact angle thereby changing the result given in Eqtn. 14 to

$${t}_{D} = t \sqrt{\frac{k}{φ}} \frac{σ cos θ}{\sqrt{{μ}_{o} {μ}_{w}}} \frac{1}{{L}_{c}^{2}} \qquad Eqtn . 15$$

Obviously Eqtn. 14 and Eqtn. 15 yield identical results when the contact angle is 0°, i.e. for the perfect wetting case. In Eqtn. 15, the term

$$\frac{1}{{L}_{c}^{2}}$$

is equivalent to Fₛ the formation shape factor used by Gupta and Civan. Use of the geometric mean of the viscosities as shown in Eqtn. 15 differs from Gupta and Civan, however.

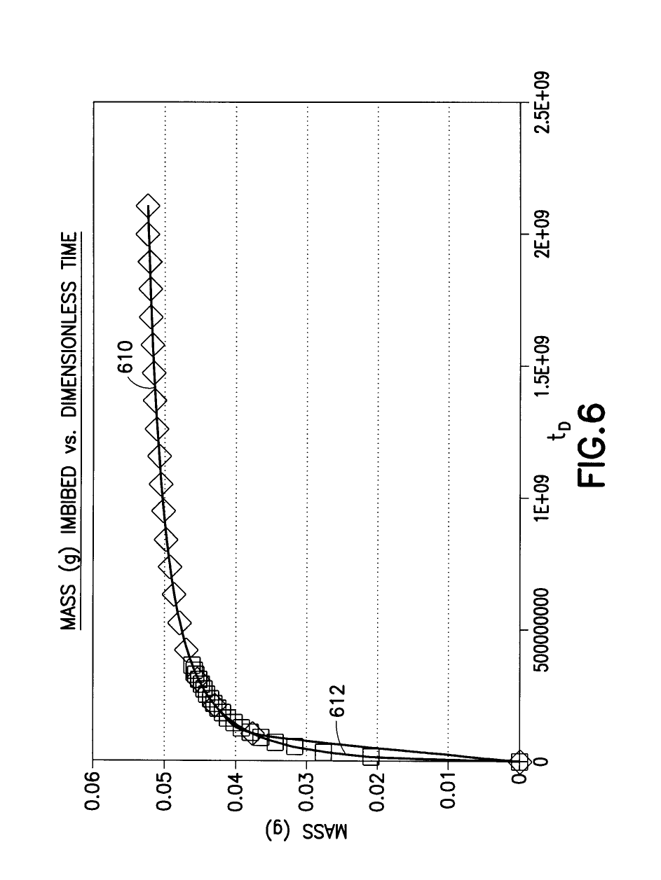

FIG. 6 is a graph showing the result when the real-time data shown in FIG. 5 are plotted vs. a dimensionless time group that incorporates the contact angle, according to some embodiments. The result for 0° is shown in curve 610, and the result for 80° is shown in curve 612. The mass imbibed data can be correlated using the contact angle in the dimensionless time group. Obviously, the case shown in FIG. 6 is idealized, but it proves the concept of using type curves to deduce wettability.

Contact Angle from Type Curves. Let's say that we have several sets of counter-current imbibition data and that at least one set of data is from a source known to be extremely water-wet—a Zisman test would confirm this. When we plot mass gained, mass gained squared, recovery data or some other suitable parameter vs. the dimensionless time as given in Eqtn. 15, we obtain a characteristic curve. Now suppose we conduct the same experiment with a sample known (Zisman test) to be quite hydrocarbon-wet and we compare the curves. That contact angle that causes the unknown curve to overlay the known curve is the advancing contact angle for the material whose wettability was previously unknown. The very important point to be made here is that proper scaling, i.e. using the correct dimensionless time group, allows us to correlate results from experiments where formation permeability and porosity, sample size and geometry, fluid surface tension and viscosity, wettability and boundary conditions all varied.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method of determining a characteristic of a rock sample relating to wettability comprising:
exposing at least a portion of the rock sample to a test fluid for a period of time such that a portion of the test fluid adsorbs onto surfaces of the rock sample and a portion of the test fluid imbibes into the rock sample;
removing at least some of the adsorbed test fluid from surfaces of the rock sample;
measuring amounts of the test fluid imbibed into the rock sample; and
deducing the characteristic of the rock sample based at least in part on the measured amounts of test fluid imbibed into the rock sample.

2. A method according to claim 1 further comprising measuring a rate associated with test fluid being imbibed into the rock sample, wherein the characteristic is deduced in part based on the measured rate.

3. A method according to claim 1 wherein the rock sample exhibits permeability in the micro- and nanoDarcy range.

4. A method according to claim 1 further comprising disaggregating the rock sample before being exposed to the test fluid.

5. A method according to claim 4 wherein the disaggregated rock sample has a mesh size between 2 and 400.

6. A method according to claim 5 where the rock sample size is between 0.1 g and 5.0 g

7. A method according to claim 1 wherein the test fluid includes aqueous solutions.

8. A method according to claim 7 wherein the test fluid comprises water, salts and/or oilfield additives.

9. A method according to claim 7 wherein the test fluid comprises water, and the measuring includes the use of a Karl Fischer titration technique.

10. A method according to claim 1 wherein adsorbed test fluid is removed from surfaces of the rock sample using a hydrophilic organic solvent.

11. A method according to claim 10 wherein the solvent comprises an alcohol.

12. A method according to claim 10 wherein the solvent is anhydrous methanol.

13. A method according to claim 10 wherein the test fluid imbibed into the rock sample is removed with a solvent.

14. A method according to claim 13 wherein the solvent comprises an hydrophilic organic solvent.

15. A method according to claim 13 wherein the solvent comprises an alcohol or a mixture of alcohols.

16. A method according to claim 15 where the solvent is anhydrous methanol.

17. A method according to claim 1 wherein adsorbed test fluid is removed from surfaces of the rock sample using a centrifuge filtering assembly.

18. A method according to claim 1 wherein adsorbed test fluid is removed from surfaces of the rock sample by a replacement process using an immiscible, low energy fluid.

19. A method according to claim 1, further comprising determining the water content of the rock sample before exposing the rock sample to the test fluid.

20. A method according to claim 2 wherein the rate associated with the test fluid being imbibed is measured by repeating the steps of exposing, removing and measuring for one or more other portions of the rock sample, and estimating the rate based on the measured amount of fluid imbibed and time of exposure to the test fluid by each portion.

21. A method according to claim 21 wherein the measuring amounts of the test fluid imbibed into the rock sample includes the use of a CT scan.

22. A method according to claim 2 further comprising determining if the rock sample is hydrophilic or hydrophobic or of mixed wettability based at least in part on the measured rate.

23. A method according to claim 1 wherein the rock sample is porous, and the wettability characteristic is deduced in part by comparing amounts of test fluid imbibed with surface tension to yield a resulting curve shape, and comparing the resulting curve shape with curve shapes of a material having known wettability.

24. A method according to claim 2 wherein the characteristic relating to wettability is deduced by comparing the rate associated with the test fluid being imbibed into the rock sample with an imbibition rate of a known sample.

25. A method according to claim 24 wherein the comparison includes plotting values relating to rate of imbibition versus a dimensionless time.

26. A method according to claim 2 wherein the deduction is based in part on a contact angle inferred by comparing measured amounts and/or rates with a type curve based on a one-dimensional diffusion model.

27. A method according to claim 1 wherein the deduction is based in part on a simulator.

28. A method according to claim 1 wherein the step of removing includes removing substantially all of the adsorbed test fluid from surfaced of the rock sample.
